(19) United States
(12) Patent Application Publication
(10) Pub. No.: US 2013/0097675 A1
(43) Pub. Date: Apr. 18, 2013

(54) POSITIONING SYSTEM FOR SERVER

(71) Applicant: WEI-DONG CONG, Shenzhen City (CN)

(72) Inventor: WEI-DONG CONG, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/598,801

(22) Filed: Aug. 30, 2012

(30) Foreign Application Priority Data
Oct. 14, 2011 (CN) 201110311447.7

(51) Int. Cl. G06F 21/20

(52) U.S. Cl. 726/4

(57) ABSTRACT

A server includes a global positioning system (GPS) module, a network port, a baseboard management controller (BMC), and a physical layer (PHY) chip. The GPS module is used to transmit the position information of the server. The BMC is utilized to receive a user message from the network port, and obtain the position information according to the request from the network port when the user is authorized to access the server. The PHY chip is coupled to a network through the network port, and is employed to send the position information to the network port from the BMC.

### BACKGROUND

1. Technical Field

The present disclosure relates to a positioning system for positioning a server.

2. Description of Related Art

Container data centers contain many servers, and the servers in the containers are often moved from place to place. It is inconvenient to maintain the servers while locations of the servers cannot be exactly positioned. Therefore, there is room for improvement in the art.

### BRIEF DESCRIPTION OF THE DRAWINGS

Many aspects of the present disclosure can be better understood with reference to the following drawing(s). The components in the drawing(s) are not necessarily drawn to scale, the emphasis instead being placed upon clearly illustrating the principles of the present disclosure. Moreover, in the drawing(s), like reference numerals designate corresponding parts throughout the several views.

FIG. 1 is a block diagram of a server system including a position system of the present disclosure.

FIG. 2 is a block diagram of a first embodiment of the positioning system.

FIG. 3 is a block diagram of a second embodiment of the positioning system.

FIG. 4 is a block diagram of a third embodiment of the positioning system.

### DETAILED DESCRIPTION

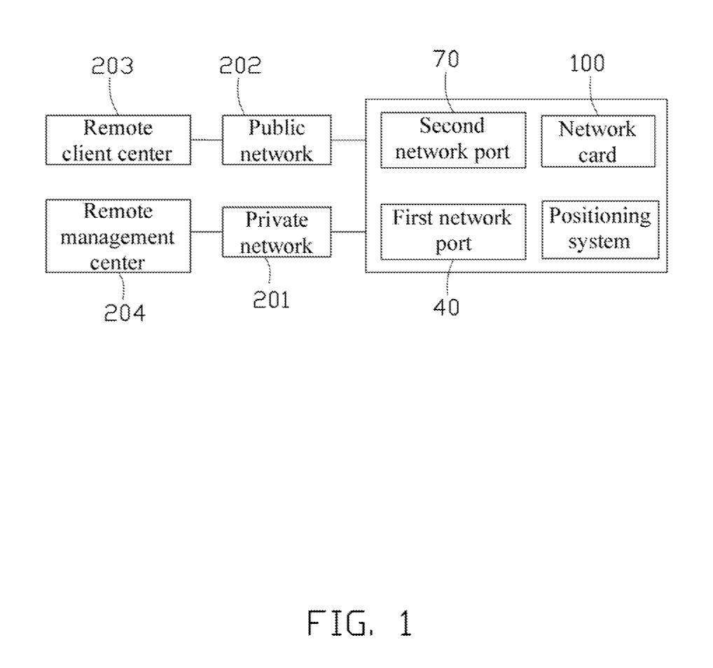

FIG. 1 illustrates a server system of the present disclosure. The server system includes a server, a private network 201, a public network 202, a remote client center 203, and a remote management center 204. The server includes a first network port 40, a second network port 70, a network card 100, and a positioning system. The network card 100 has a unique media access control (MAC) address so that the server can be identified according the MAC address. The network card 100 stops operating when the server is power-off. The first network port 40 is coupled to the remote management center 204 through the private network 201. The second network port 70 is coupled to the remote client center 203 through the public network 202. The first network port 40 and the second network port 70 are registered jack-45 (RJ-45) interfaces. The public network 202 can be accessed from an outside network, such as internet. The private network 201 is a local area network that can be accessed only in the inner network.

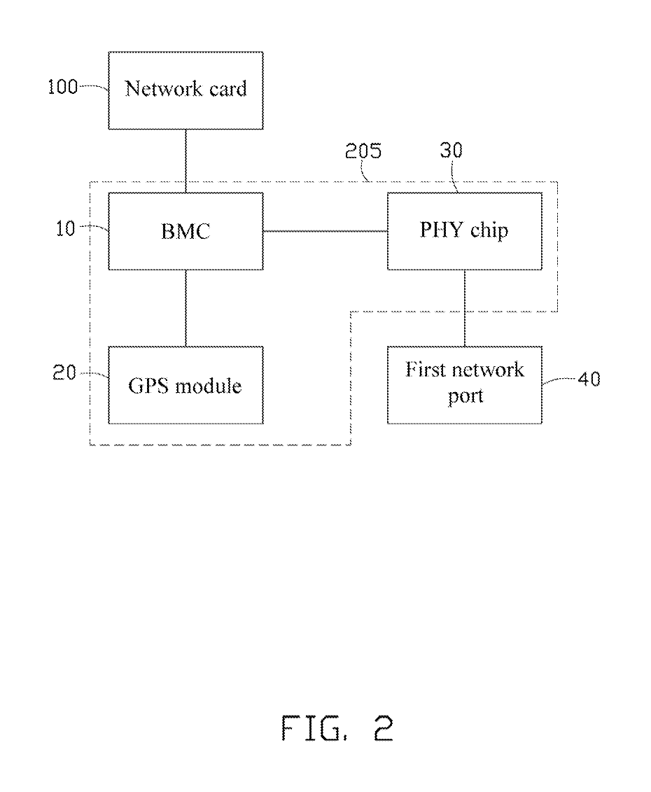

FIG. 2 illustrates a first exemplary embodiment of the positioning system 205. The first exemplary embodiment of the positioning system 202 includes a baseboard management controller (BMC) 10, a global positioning system (GPS) module 20, and a physical layer (PHY) chip 30.

The PHY chip 30 connects to the first network port 40 for communicating with the remote management center 204. The BMC 10 can communicate with the remote management center 204 through the PHY chip 30 when the server is power-off. The GPS module 20 can be powered by an auxiliary power source of the server, so that the GPS module 20 can output the positioning information of the server when the server is power-off.

The BMC 10 includes a universal asynchronous receiver/transmitter (UART) interface to communicate with the GPS module 20 for acquiring the position information of the server.

The BMC 10 is connected to the network card 100 and saves the MAC address of the network card 100 for identifying the server. When a user in the remote management center 204 requests to access the server, an identification message including the name and the password of the user is sent to the BMC 10 through the first network port 40 and the PHY chip 30 in that order. The BMC 10 verifies the identification message and authorizes the user to access the server. Then, the BMC 10 obtains the position information from the GPS module 20, and sends the position information of the server to the user, sequentially through the PHY chip 30 and the first network port 40.

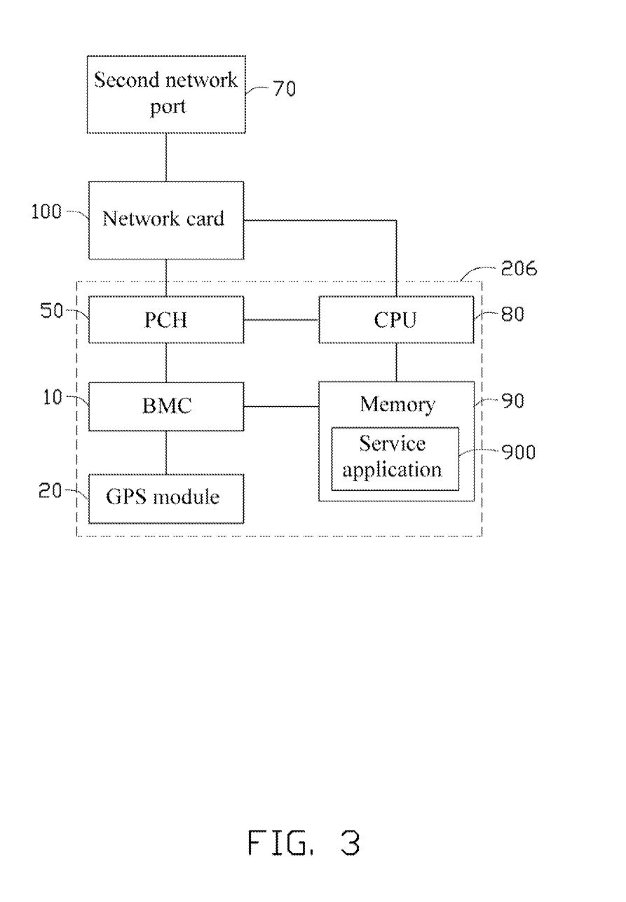

FIG. 3 illustrates a second exemplary embodiment of the positioning system 206. The positioning system 203 includes a platform controller hub (PCH) 50, a central processing unit (CPU) 80 coupled to the PCH 50, a BMC 10 coupled to the PCH 50, a GPS module 20, and a memory 90. The memory 90 includes a service application 900 function as a control unit.

The PCH 50 is connected to the network card 100 and includes a low pin count (LPC) bus connected to the BMC 10. The BMC 10 includes a universal asynchronous receiver/transmitter (UART) interface to communicate with the GPS module 20 for acquiring the position information of the server. The MAC address of the network card 100 is saved in the memory 90 for identifying the server.

When the server is power-on and a user in the remote client center 203 request to access the server, an identification message including the name and the password of the user is sent to the network card 100 through the second network port 70. The PCH 50 receives the identification message from the network card 100, and sends the identification message to the CPU 80. The CPU 80 executes the service application 900 in the memory 90, to process the request from the PCH 50. The service application 900 verifies the identification message and authorizes the user to access the server. Then, the service application 900 obtains the positioning information of the server from the GPS module 20 by the BMC 10. The position information is then sent to the user, sequentially through the CPU 80, the network card 100, and the second network port 70.

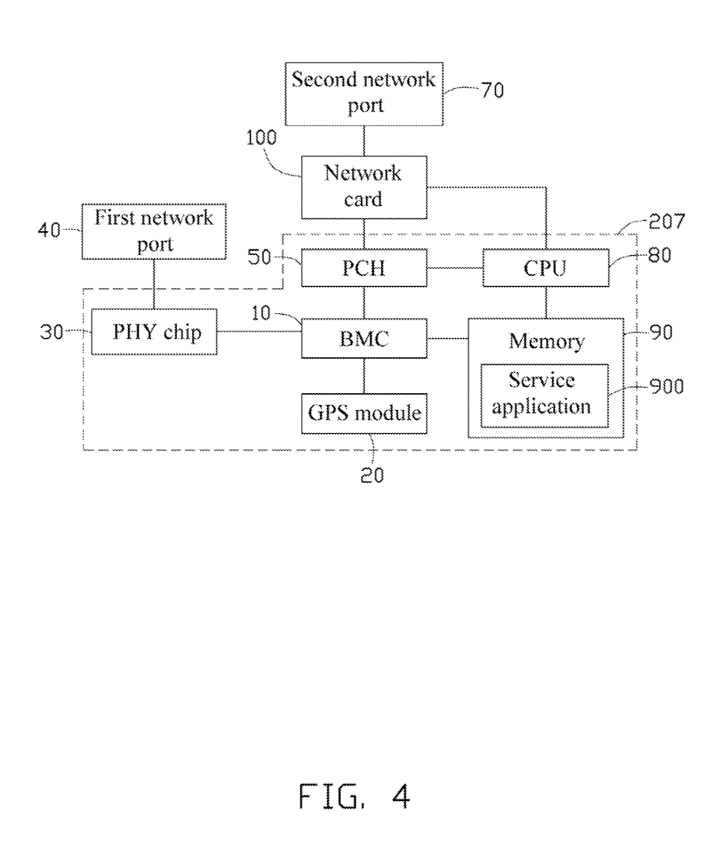

FIG. 4 illustrates a third exemplary embodiment of the positioning system 207, which is a combination of the first and the second exemplary embodiments. The positioning system 204 includes a physical layer (PHY) chip 30, a platform controller hub (PCH) 50, a central processing unit (CPU) 80 coupled to the PCH 50, a BMC 10 coupled to the PCH 50, a GPS module 20, and a memory 90. The BMC 10 saves the MAC address of the network card 100. When the server is on or off, the user may obtain the position information of the server through the PHY chip 30 and the first network port 40, the BMC 10 acquires the position information of the server from the GPS module 20, and sends the position information of the server to the user. Alternatively, when the server is on, the user may obtain the position information through the second network port 70 and the network card 100.

While the disclosure has been described by way of example and in terms of preferred embodiment, it is to be understood that the disclosure is not limited thereto. To the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. A positioning system set in a server for positioning the server, comprising:
a global positioning system (GPS) module providing a positioning information of the server;
a baseboard management controller (BMC); and
a physical layer (PHY) chip connected between the BMC and a network port of the server, wherein a user requests to access the server through a network coupled to the network port, the BMC verifies an identification message comprising the name and the password of the user, the BMC sends the position information from the GPS module to the user when the user is authorized to access the server.

2. The positioning system of claim 1, wherein the network port is a registered jack-45 (RJ-45) interface.

3. The positioning system of claim 1, wherein a media access control (MAC) address of a network card of the server is saved in the BMC and the server is identified according to the MAC address.

4. The positioning system of claim 1, wherein the BMC comprises a universal asynchronous receiver/transmitter (UART) interface to communicate with the GPS module.

5. The server of claim 1, wherein the network is a local area network.

6. A positioning system set in a server for positioning the server, comprising:
a global positioning system (GPS) module providing a positioning information of the server;
a baseboard management controller (BMC) coupled to the GPS module;
a platform control hub (PCH) coupled between the BMC and a network card of the server;
a memory saving the position information and comprising a service application; and
a central processing unit (CPU) coupled between the PCH and the memory, the CPU executing the service application in the memory, wherein a user requests to access the server through a network and a network port of the server coupled to the network card, the service application verifies an identification message comprising the name and the password of the user, the position information is sent to the user through the network card, the network port, and the network when the user is authorized to access the server.

7. The positioning system of claim 6, wherein the network port is a RJ-45 interface.

8. The server of claim 6, wherein the network card comprises a unique media access control (MAC) address for identifying the server.

9. The positioning system of claim 6, wherein the PCH comprises a low pin count (LPC) bus to communicate with the BMC.

10. The positioning system of claim 6, wherein the BMC comprises a universal asynchronous receiver/transmitter (UART) interface to communicate with the GPS module.

11. A positioning system set in a server for positioning the server, comprising:
a global positioning system (GPS) module providing a positioning information of the server;
a baseboard management controller (BMC) coupled to the GPS module;
a platform control hub (PCH) coupled between the BMC and a network card of the server, the network card coupled to a first network through a first network port;
a memory coupled to the BMC, saving the position information of the GPS, and comprising a service application;
a central processing unit (CPU) coupled between the PCH and the memory, the CPU executing the service application in the memory; and
a physical layer (PHY) chip coupled to a second network through a second network port;
wherein when a user in the first network requests to access the server, the service application verifies an identification message comprising the name and the password of the user, the position information is sent to the user through the network card, the first network port, and the first network when the user is authorized to access the server; when a user in the second network requests to access the server, the BMC verifies the identification message and sends the position information acquired from the GPS module to the user through the second network port and the second network in that order when the user is authorized to access the server.

12. The positioning system of claim 11, wherein the first and second network ports are RJ-45 interfaces.

13. The positioning system of claim 11, wherein a media access control (MAC) address of a network card of the server is saved in the BMC and the server is identified according to the MAC address.

14. The positioning system of claim 11, wherein the BMC comprises a universal asynchronous receiver/transmitter (UART) interface to communicate with the GPS module.

15. The positioning system of claim 11, wherein the second network is a local area network.

16. The positioning system of claim 11, wherein the first network is an internet.
